(19) United States
(12) Patent Application Publication
(10) Pub. No.: US 2004/0254511 A1
(43) Pub. Date: Dec. 16, 2004

(54) Ped. scrubber, exfoliator foot shower

(76) Inventor: Christian Patrick Brborich, Long Beach, CA (US)

Correspondence Address: CHRISTIAN BRBORICH, P.O. BOX 943, HERMOSA BEACH, CA, 90254, US

(21) Appl. No.: 10/424,115

(22) Filed: Apr. 28, 2003

(51) Int. Cl. A61H 9/00

(52) U.S. Cl. 601/160

(57) ABSTRACT

An advanced, portable, compact and novel foot shower. The unit includes a casing having a tub for receiving the foot and water. It will scrub the foot with loofah sponges on the bottom of the unit connected to a vibrator plate. It will include pumice stones on the sides for buffing and scrubbing the feet. The unit is designed with the front of the casing higher while lowering at the back for easy flow of water. This hydrotherapy & hydromassage will create reflexolgy that is proven to be beneficial for the well being of internal organs.

### BACKGROUND OF INVENTION

The advanced and novel invention, provides a comforting, refreshing and soothing hydrotherapy and hydro-hygiene devices and devices that apply massage-type effect to human extremities placed within the apparatus. As the foot is scrubbed by electric movement and vibration, the user is also receiving reflexology, that is certainly a proven practice not only for the well-being of the feet, but for the internal organs as well.

A foot has many vital points identified in oriental medical science, which are closely related with various organs. It is well known that stimulation of the vital points of the foot causes fatigue such as stiffness in the shoulders to be relieved and the internal organs and the nervous system to be restored.

More than 60% of the body's blood is collected in the legs. Accordingly, since a person leads an active life while standing up for long periods of time, the body parts where congestion tends to occur include the legs. Thus, it is known that making ageing begins in the feet.

Also, feet, which are closed by socks or shoes to be prevented from breathing, tend to become among the dirtiest of the various parts of the body and have the most unnatural stress applied thereto. This causes fatigue to be promoted and the internal organs to be adversely effected. Although the feet are the most important parts of the body as noted from the foregoing, people have an indifference towards the feet and in some instances can not reach the feet because of many factors, such as; obesity, advanced ageing, causing dizziness. Pregnancy, many handicapped reasons, people on the “run”, that are pressed for time, and of course, plain laziness. Parents will find it useful for their children to help keep the feet clean and healthy.

### SUMMARY OF INVENTION

Accordingly, it is the object of the present invention to provide a new and improved foot shower adapted for total hygiene, to clean, exfoliated dead skin, massage and radiate reflexology treatment to the foot, to promote stimulation of the vital points. Hydrotherapy—hydro hygiene device that is more attractive to the desires of potential users.

Another object of the present invention is to provide such a hydro hygiene device that is readily manufactured by normal manufacturing techniques, so as to result in ultimate cost effectiveness.

A further object of the present invention is to provide a device, which is highly effective while yet capable of being manufactured in an economical manner when considered in the light of its advantageous results.

It is another object of this invention to provide a foot shower adapted for a foot container to receive hot, warm and cold-water jet to the foot from the bathtub faucet or other water jet stream available. A very important feature is the ease of drainage of water with no heavy lifting.

Structure is provided under the bath container for a battery-operated vibration that is connected to the plastic frame the holds the snap-on loofah pad.

Still another object of this invention is to provide a totally novel message device. A soft loofah pad, on the bottom of the container that will stimulate the bottom of the foot as it cleans the foot with soap bubbles that comes up through the loofah by air holes.

An air transferring pipe is connected to the motor and the bottom of the foot shower container that pumps air through the loofah creating bubbles as it comes in contact with the water.

The heel and the sides of the foot will be stimulated as the foot is rubbed against the pumice stones to exfoliate dead ski8n cells, thus creating a soft touch and new skin to the foot.

Another novelty of this invention is the brush place at the front of the foot shower container to brush the toes and between each and every toe to elimate dead skin and bad odor to affected areas.

One of the most important features of this invention is the safety handle. It will have adjustability for height and safety handles that will create balance and stability for the body as needed as the user operates the Foot Shower.

### DESCRIPTION OF THE PREFERRED EMBODIMENTS

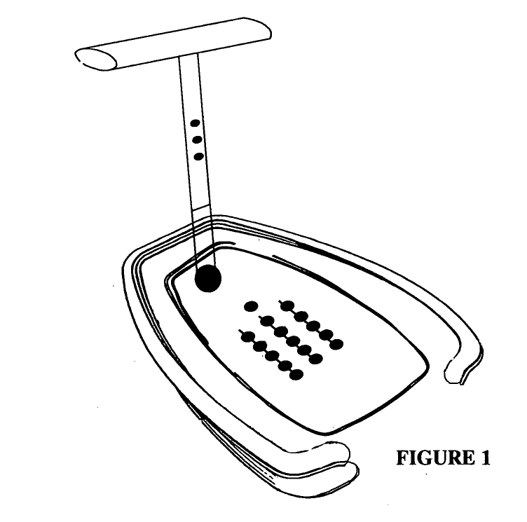

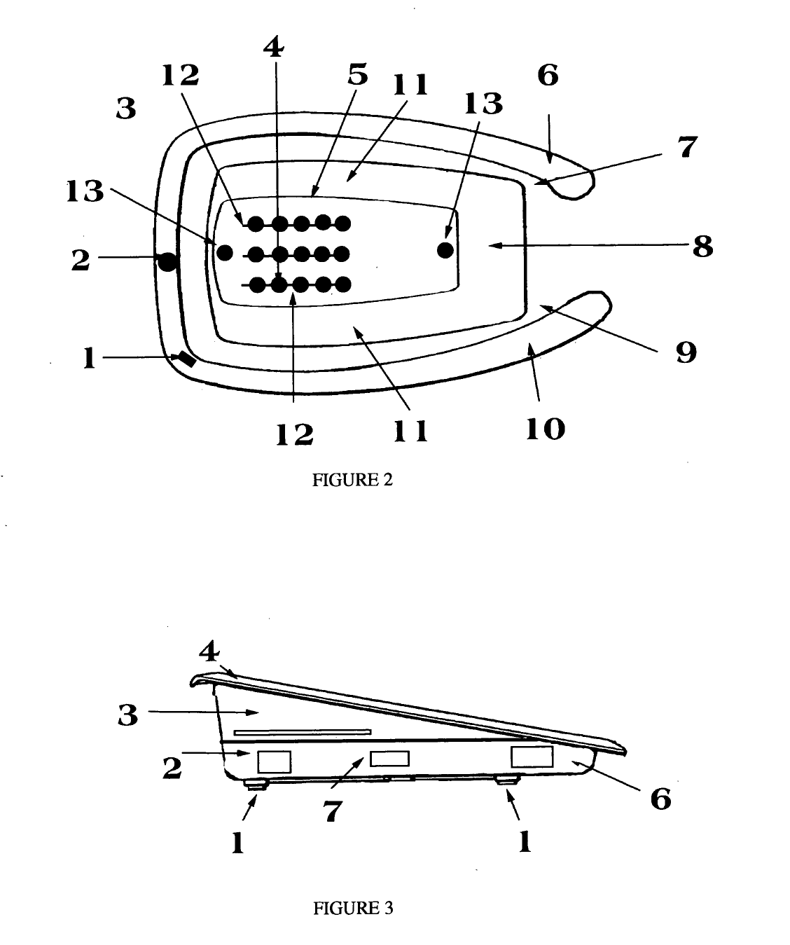

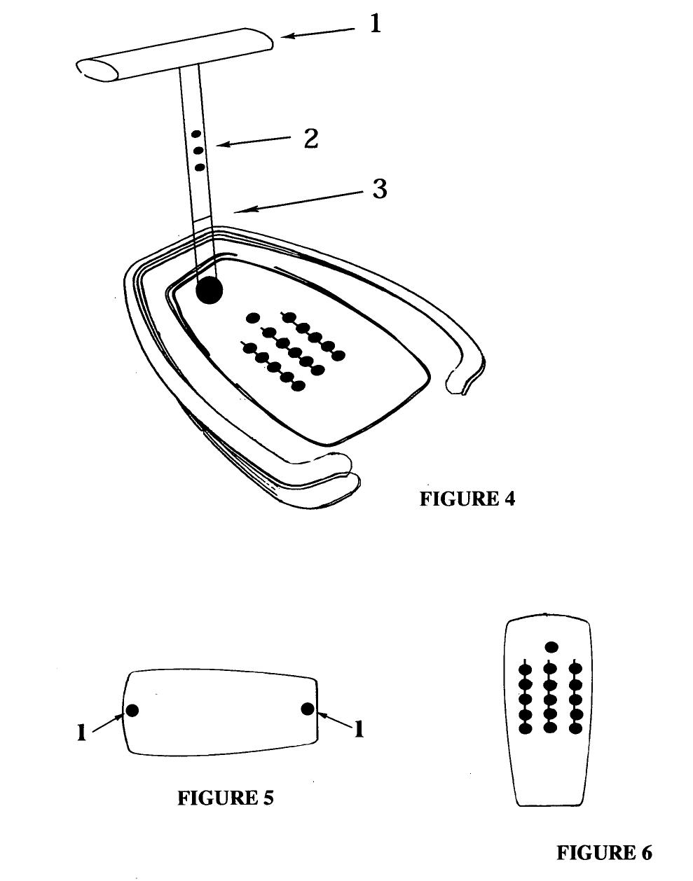

In the embodiment of the present invention as shown in FIGS. 1-6, there is provided a foot shower unit which includes a casing FIG. 1, having a lower portion and an upper portion, FIG. 3. The casing is preferably made of high grade molding plastic and portions and are connected by suitable sealing means. As shown in FIG. 3. The upper casing has upstanding side walls which terminate at their lower ends in a floor. A foot receiving station, FIG. 2, allowed into floor and is spaced apart sufficiently to allow the user to place the foot thereon in a comfortable position.

As shown in FIG. 2, the foot receiving station is provided with a raised curved arched portion loofah, FIG. 2-5 which is anatomically placed to cradle the foot. Such arched portion is sufficiently raised along the middle surface thereof as to accommodate the higher arch construction. Thus, as the foot receiving station FIG. 2 is larger than the foot of most persons, by moving the feet across the surface of the station, a position can be found which will provide a correct and comfortable contact with the surfaces of the station throughout the entire area of the soles of the foot.

The “U” shaped casing FIG. 2, is supported on four suction cups for safety. FIG. 3-2. Two at the upper round portion FIG. 3-1 and one on each side of the open back portion of the unit. Drainage of the water being used is provided at the back of the unit FIG. 3 that is open and slightly slanted downward toward the surface of the bathtub.

The upper casing portion FIG. 3 terminates along the compartment which projects upward from floor to a height equal to that of the sidewalls of the casing. Compartment is of substantially uniform size across the casing and provides housing for the vibrating plate attached to the battery and houses the motor, pumps and unit control switch assembly.

The switch assembly FIG. 3 includes a conventional slide switch FIG. 2-1, with integral switch cap holder which is intermitted with and secured to switch cap by screw means. The switch is attached to the casing by suitable securing means. An O-ring, of neoprene rubber or other suitable material, is located between the switch cap and the casting, with the O-ring being positioned in a circular notch formed in the upper surface of the casing. In this manner there is obtained a sealing, fluid-tight engagement between the switch cap and the casing, thus providing a waterproof construction for the switch assembly.

The water stream, will come directly from the faucet of the bathtub onto the foot being washed. The unit will have an open back FIG. 2 and the front of the foot, the toe area FIG. 2-3 will be slightly tilted upward allowing the heel of the foot to slant down on the tub of the unit. This will allow the flow of clean water to run freely and easily allow the unit to drain.

A notch to support the replaceable brush FIG. 2-13 will be provided in the front part of the container. An elongated pumice stone will be attached on each side of the unit FIG. 2-11, by special guard clasp on each side of the pumice stone. This clasp will allow the stones to be replaceable too.

### DESCRIPTION OF THE PREFERRED EMBODIMENTS—PAGE 2

The waterproof encased battery FIG. 3-2, will be located on one side of the “U” shaped container. The wires from the battery will run through small circular tubes FIG. 2-12 that have a clasp at the end of the wiring, this will hook on to plastic plate FIG. 6 that holds the loofah pad FIG. 3-3, movement and vibration to the foot. The plate will also have small holes FIG. 6 to allow the flow of water and air FIG. 2-4 creating bubbles that will filter through the loofah FIG. 2-5.

The motor FIG. 3-7 runs the pump which provides the airflow FIG. 3-6, to the loofah plate. The motor is run by batteries located in the front of the compartment FIG. 3-2.

The unit of the invention gives the feet a massaging shower, which refreshes, relaxes, activates blood circulation and softens calluses and avoids tired and aching feet. Most of all it offers complete hygiene with less effort. Either hot, warm or cold water can be used.

The operation and use of the invention hereinabove described will be evident to those skilled in the art to which it relates from a consideration of the foregoing.

It will be seen that there is provided a device in which the several objects of this invention are achieved, and which is well adapted to meet the conditions of practical use. The useful features of the invention are easily seen.

It is thought that persons skilled in the art to which this invention relates will be able to obtain a clear understanding of the invention after considering the foregoing description in connection with the accompanying drawing. Therefore, a more lengthy description is deemed unnecessary.

It is to be understood that various changes in shape, size and arrangement of the elements of this invention as claimed may be resorted to in actual practice, if desired.

Having thus described the invention, what is claimed as new and to be secured by Letters Patent is:

1. A portable hydrotherapy and hydro-hygiene foot shower-massaging unit, comprising of an open container that receives water from a faucet in the bathtub or other water jet stream available.

2. A plate fitting on the bottom of said container, a manifold assembly of a plurality of connecting conduits each having spaced their own discharge of operations.

3. A curved arched replaceable soft loofah to cradle and vibrate the foot with massaging effect.

4. The replaceable pumice stone on each side of the unit.

5. Replaceable brush for the cleansing of the toes.

6. Adjustable security pole handle for stability and balance.

7. Waterproof encasings for battery, motor and water pumps, battery operated vibration plate.

8. Suction cups to hold the unit secure and in place.
